(19) United States
(12) Patent Application Publication
(10) Pub. No.: US 2025/0259431 A1
(43) Pub. Date: Aug. 14, 2025

(54) AUTHENTICATING VIDEOS USING AI AND BLOCKCHAIN TECHNOLOGIES

(71) Applicant: Binarii Labs Ltd., Dublin (IE)

(72) Inventor: Steven Garner, London (GB)

(21) Appl. No.: 18/438,646

(22) Filed: Feb. 12, 2024

(51) Int. Cl. G06V 10/82; H04L 9/00; H04L 9/32

(52) U.S. Cl. CPC G06V 10/82; H04L 9/3236; H04L 9/50

(57) ABSTRACT

Disclosed is a method of authenticating a digital video file on a video authentication data processing platform, comprising steps of: receiving a digital video file which is being introduced to the video authentication data processing platform; processing the received digital video file using an artificial intelligence (AI) agent, which includes an artificial neural network, resulting in identifying a plurality of fragments of the received digital video file which are determined by the AI agent as being authentication candidates which are representative of an entirety of the received digital video file; generating a hash of each of the plurality of fragments of the received digital video file; and storing the generated hashes on a blockchain.

### TECHNICAL FIELD

This application generally relates to video consumption, transmission and storage, and more particularly, to verifying and authenticating a video.

### BACKGROUND

In today's world, digital creation or manipulation of videos has become common place, especially with “deepfakes” and other artificial intelligence produced content, and consumers can sometimes struggle in identifying real and fake video content such as those which are parodies or memes. Protecting videos from piracy has always been a problem for the film industry and there are a number of counterfeit measures available. However, with the proliferation of easy to use AI apps, videos can be created quickly and sometimes streamed in real time. Authenticating a video as legitimate, such as determining whether the actors in a video are simulations without the consent of the real actors, is problematic. Typically, the consumer, or the distributing server platform, cannot distinguish between a real or imitation video.

### SUMMARY

The invention provides a method of authenticating a digital video file on a video authentication data processing platform comprising steps of: a) receiving a digital video file which is being introduced to the video authentication data processing platform; b) processing the received digital video file using an artificial intelligence (AI) agent, which includes an artificial neural network, resulting in identifying a plurality of fragments of the received digital video file which are determined by the AI agent as being authentication candidates which are representative of an entirety of the received digital video file; c) generating a hash of each of the plurality of fragments of the received digital video file; and d) storing the generated hashes on a blockchain.

Also provided is a corresponding system having a processor for executing instructions for carrying out the steps of the method, and a computer program for, when executed on a computer system, causing the computer system to carry out the steps of the method.

Preferably, after the steps a)-d) are performed, when a user sends a user request from a video consumer device, to view the digital video file, the further steps are carried out: e) the digital video file is again received by the video authentication data processing platform in response to the user request, f) a hash is again generated of each of the plurality of fragments of the digital video file received at step (e); and g) the hashes stored on the blockchain at step (d) are compared to the hashes generated at step (f); and h) if the comparison result at step (g) indicate a match, then a notification is provided to the video consumer device to notify the user that the digital video file has been authenticated.

Preferably, wherein at step (b), the plurality of fragments are vertical frames of the digital video file.

Preferably, at step (b), the plurality of fragments are horizontal fragments of the digital video file.

Preferably, at step (a), metadata associated with the digital video file is also received and used by the AI agent at step (b) to identify the plurality of fragments.

Preferably, the metadata includes any one of a name of the digital video file, a data when the digital video file was created, a data format of the digital video file, or a compression type of the digital video file.

Preferably, a hash is also generated of a sum of the hashes generated at step (c), and the hash of the sum of the hashes is also stored on the blockchain at step (d).

Preferably, at step (b) the AI agent identifies the plurality of fragments by recognising specific characteristics of the digital video file.

Preferably, the specific characteristics of the digital video file include a specific colour appearing in a specific portion of the digital video file.

Preferably, the specific characteristics of the digital video file include an identification of a particular person whose face appears in the digital video file, by using a facial recognition algorithm.

Preferably, at step (h), if the comparison result at step (g) indicates that the hashes do not match, then a notification is provided to the video consumer device to notify the user that the digital video file has not been authenticated.

Preferably, a further step (i) is included, of providing the digital video file to the video consumer device.

This application is directed to validating/authenticating videos using AI and blockchain technology. Use of blockchain technology for storing hashes of video data is significantly faster, more efficient and less costly than the current processes. Use of AI technology allows for only a small subset of the total video data to be identified and subsequently used in the authentication process, therefore greatly reducing the amount of video data that needs to be processed and stored, allowing for a large saving in terms of processor time. According to exemplary embodiments, simple proof of record validation can be used where the record is a derivative of a slice (or fragment) or combination of slices (or fragments) of the video.

### BRIEF DESCRIPTION OF THE DRAWINGS

FIG. 1 is a block diagram showing a plurality of data processing units which interact with each other over a computer network according to an embodiment of the disclosed technology;

FIG. 2 is a flow chart showing steps of operation of the interaction between the data processing units shown in FIG. 1;

FIG. 3 is an illustration of an example of the disclosed technology in operation; and

FIG. 4 is a flow chart showing steps of operation when a user wants to view a specific video.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “transmission” may have been used in the description of embodiments, the application may be applied to many types of network data, such as, packet, frame, datagram, etc. The term “transmission” also includes packet, frame, datagram, and any equivalents thereof. Furthermore, while certain types of transmission may be depicted in exemplary embodiments they are not limited to a certain type of message, and the application is not limited to a certain type of transmission.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

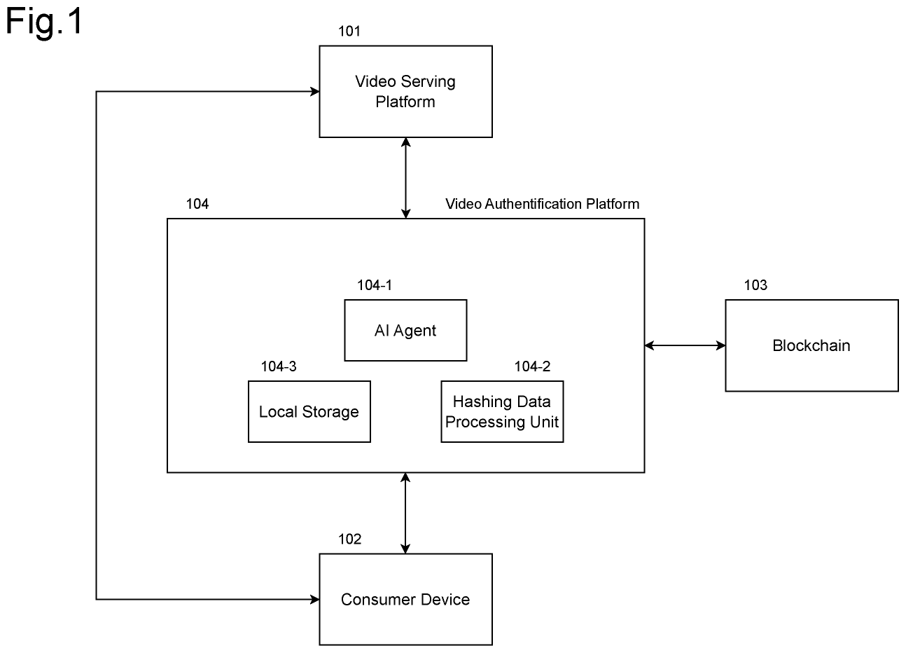

FIG. 1 illustrates a video transmission and consumption network whereby a user consumes a video program (such as a film) on a consumer device 102 (such as a smartphone, television, set top box, or tablet), where a digital video file of the video has been distributed or transmitted to the consumer device 102 from a video serving platform 101, such as a server computing device or data centre hosting a plurality of such server computing devices.

According to one illustrative embodiment, a video which is sent in digital format from the serving platform 101 on its way to the consumer device 102 is first sent to a video authentication platform 104 which is implemented on a server computing device or on a data centre hosting a plurality of such server computing devices. The video authentication platform 104 includes, in addition to other standard software and hardware components, an AI agent, 104-1, which performs processing functions regarding digital videos received by the video authentication platform 104 as will be described below.

Also shown in FIG. 1 is a blockchain 103, which is a standard network of peer-to-peer data processing units, such as server computing devices or a plurality of such server computing devices implemented in a data centre. As will be described below, data regarding videos which are processed by the video authentication platform 104 is stored on the blockchain 103 for authentication purposes.

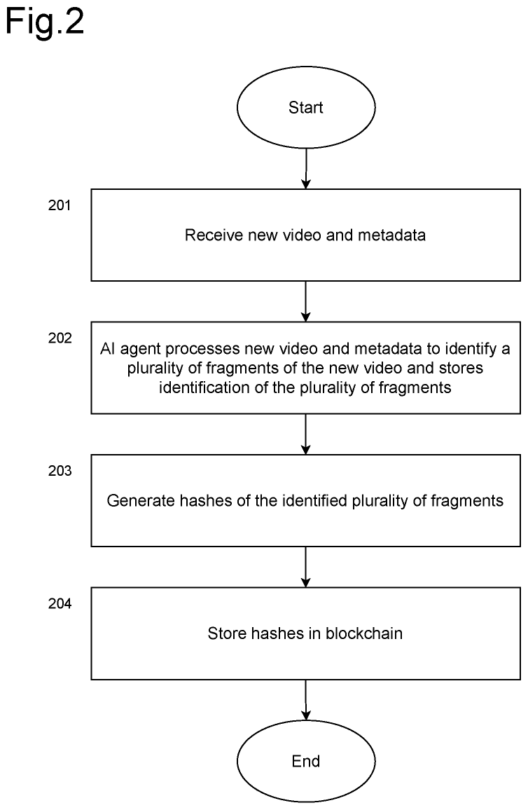

A description will now be given of a series of processing steps, as illustrated in FIG. 2, which are carried out, according to a preferred embodiment, by the video authentication platform 104 when a new video is being introduced to the video transmission and consumption network shown in FIG. 1.

At step 201, a new video, which is being introduced for the first time to the video transmission and consumption network of FIG. 1, is received by the video authentication platform 104 having been sent to the platform 104 by, for example, the serving platform 101. A new video could, however, be sent to the video authentication platform 104 by any other video producing unit not shown in FIG. 1, such as, for example, a video production company, such as a film studio or news distribution network, or even from a consumer who has made a video using a smart phone.

At step 201, the new video received by the video authentication platform 104 can also include metadata associated with the new digital video file, such metadata including, for example, a title of the video, subject matter of the video, an identification of the video film studio that has produced the new video, a date when the new video was made, a data format of the new video (such as MP4 or AVI), a type of video compression used on the new video, a longitude and latitude of the geographical location where the new video was filmed, and what editing software has been used to edit the video.

At step 202, once the new digital video file, and possibly also its metadata, have been received at the video authentication platform 104, the AI agent 104-1 running in the platform 104 processes the new video (and its metadata) to identify a plurality of fragments of the new video, where such fragments are to be used for authentication purposes. The identified fragments, or identifying information about the identified fragments, are stored in a local storage 104-3.

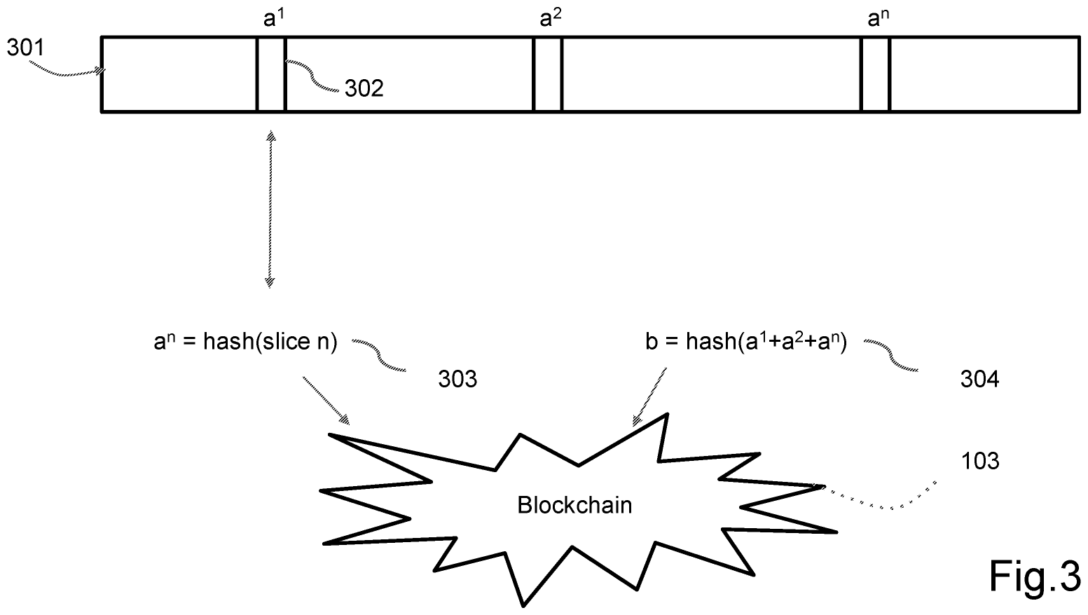

For example, as shown in FIG. 3, a video 301 (a new video that has been received by the platform 104) is shown with a plurality of fragments (a1, a2 to an) of the video 301. A starting and ending frame are also shown. As shown in FIG. 3, the plurality of fragments are less than the entirety of the digital video file, and will usually make up a small percentage of the overall video 301. For example, the fragments could be three vertical frames of the video.

The fragments (a1, a2 to an) are identified by the AI agent 104-1 agent by taking in the digital video file and possibly also its metadata as input and processing this input using machine learning algorithms and models, to take advantage of an offline training phase that has been accomplished by training such algorithms and models using a large amount of training data, in advance of real time operation of the platform, in order that the AI agent 104-1 can identify patterns, looking for specific characterics, in the input data and accordingly generate output classifications and results accordingly.

The AI agent 104 could implement any one or more of the many different types of MLAs (Machine Learning Algorithms) known in the art. Broadly speaking, there are three types of MLAs: supervised learning-based MLAs, unsupervised learning-based MLAs, and reinforcement learning based MLAs.

Supervised learning MLA process is based on a target-outcome variable (or dependent variable), which is to be predicted from a given set of predictors (independent variables). Using these set of variables, the MLA (during training) generates a function that maps inputs to desired outputs. The training process continues until the MLA achieves a desired level of accuracy on the validation data. Examples of supervised learning-based MLAs include: Regression, Decision Tree, Random Forest, Logistic Regression, etc.

Unsupervised learning MLA does not involve predicting a target or outcome variable per se. Such MLAs are used for clustering a population of values into different groups, which is widely used for segmenting customers into different groups for specific intervention. Examples of unsupervised learning MLAs include: a priori algorithm, and K-means.

Reinforcement learning MLA is trained to make specific decisions. During training, the MLA is exposed to a training environment where it trains itself continually using trial and error. The MLA learns from past experience and attempts to capture the best possible knowledge to make accurate decisions. An example of reinforcement learning MLA is a Markov Decision Process.

It should be understood that different types of MLAs having different structures or topologies may be used for various tasks. One particular type of MLAs includes artificial neural networks (ANN), also known as neural networks (NN).

Generally speaking, a given NN consists of an interconnected group of artificial “neurons”, which process information using a connectionist approach to computation. NNs are used to model complex relationships between inputs and outputs (without actually knowing the relationships) or to find patterns in data. NNs are first conditioned in a training phase in which they are provided with a known set of “inputs” and information for adapting the NN to generate appropriate outputs (for a given situation that is being attempted to be modelled). During this training phase, the given NN adapts to the situation being learned and changes its structure such that the given NN will be able to provide reasonable predicted outputs for given inputs in a new situation (based on what was learned). Thus, rather than attempting to determine a complex statistical arrangements or mathematical algorithms for a given situation, the given NN aims to provide an “intuitive” answer based on a “feeling” for a situation. The given NN is thus regarded as a trained “black box”, which can be used to determine a reasonable answer to a given set of inputs in a situation when what happens in the “box” is unimportant.

NNs are commonly used in many such situations where it is only important to know an output based on a given input, but exactly how that output is derived is of lesser importance or is unimportant. For example, NNs are commonly used to optimize the distribution of web-traffic between servers and in data processing, including filtering, clustering, signal separation, compression, vector generation and the like.

In some non-limiting embodiments of the present technology, the NN can be implemented as a deep neural network. It should be understood that NNs can be classified into various classes of NNs and one of these classes comprises recurrent neural networks (RNNs).

RNNs are adapted to use their “internal states” (stored memory) to process sequences of inputs. This makes RNNs well-suited for tasks such as unsegmented handwriting recognition and speech recognition, for example. These internal states of the RNNs can be controlled and are referred to as “gated” states or “gated” memories.

It should also be noted that RNNs themselves can also be classified into various sub-classes of RNNs. For example, RNNs comprise Long Short-Term Memory (LSTM) networks, Gated Recurrent Units (GRUs), Bidirectional RNNs (BRNNs), and the like.

LSTM networks are deep learning systems that can learn tasks that require, in a sense, “memories” of events that happened during very short and discrete time steps earlier. Topologies of LSTM networks can vary based on specific tasks that they “learn” to perform. For example, LSTM networks may learn to perform tasks where relatively long delays occur between events or where events occur together at low and at high frequencies. RNNs having particular gated mechanisms are referred to as GRUs. Unlike LSTM networks, GRUs lack “output gates” and, therefore, have fewer parameters than LSTM networks. BRNNs may have “hidden layers” of neurons that are connected in opposite directions which may allow using information from past as well as future states.

Another example of the NN that can be used to implement non-limiting embodiments of the present technology is a residual neural network (ResNet).

Deep networks naturally integrate low/mid/high-level features and classifiers in an end-to-end multilayer fashion, and the “levels” of features can be enriched by the number of stacked layers (depth).

To summarize, the implementation of at least a portion of the one or more MLAs in the context of the present technology can be broadly categorized into two phases-a training phase and an in-use phase. First, the given MLA is trained in the training phase using one or more appropriate training data sets. Then, once the given MLA learned what data to expect as inputs and what data to provide as outputs, the given MLA is run using in-use data in the in-use phase.

A plurality of fragments of the digital video file are identified by the AI agent 104-1 in order to arrive at a subset of the total of all fragments of the video file, where the subset provides a good representative sample of all fragments of the video, where the representative sample is selected for use in further processing (as will be described below) for authenticating the overall video instead of using all of the fragments of the video (which would involve too much processing and storage). The AI agent 104-1, with its pre-trained algorithms and models, trained to recognise certain patterns or specific characteristics in the input video and metadata, is used to select a subset of the total fragments, to thereby reduce the amount of processing and storage involved, while still achieving a good authentication result.

For example, the AI agent 104-1 may recognise from the metadata that a particular new video is a football match and therefore look for certain contextual information in the video, such as green grass near the bottom of the screen. The AI agent could select horizontal fragments (going in the direction of the moving video) focussing on the bottom portion of each of a plurality of frames of the video where the grass would be expected to be. Once the AI agent recognises, by taking a sample of the overall total fragments, that the grass is green at the bottom of the frame, over several frames, this would provide a confirmation that the AI agent has correctly recognised the video as the football match that the metadata claims that the video portrays.

Rather than taking horizontal fragments, the AI agent could also take vertical fragments (in a direction perpendicular to the direction of the moving video) such that the entire frame is taken from the top to the bottom at a certain point in time. Any information contained in that frame could then be analysed and used for recognition purposes, such as a close up of a human face. The AI agent could use facial recognition algorithms/models to then recognise the identity of the human actor in the frame. This could help to determine whether the video is a fake, which fake video uses fake actors instead of the real actors.

In the above examples, a frame length or size can be determined by the AI agent, 104-1.

As a further alternative to taking horizontal or vertical fragments of a plurality of video frames, a particular portion of each of a series of video frames could be looked at by the AI agent, such as, for example, looking for a full moon in the top right hand corner of each frame, so that the AI agent can confirm that it remains night time in the scene. Every 10^{th} frame could be checked to see if the moon is still there in the same place. If the moon would go away, this could provide an indication that the video may not be authentic.

The AI agent could also pick objects located in a particular circular portion, for example, of a randomly selected plurality of frames, looking, for example, for a particular human face in those frames and then using facial recognition algorithms to determine if the same face has been identified as in the previous frames.

Once the AI agent 104-1 has identified the fragments of the video that it has selected as being the best candidates for use in authentication processing, the platform's processing steps proceed to step 203 where a hash of each of the identified fragments of the video is calculated (see 303 of FIG. 3) by a hashing data processing unit 104-2 and the hashes, once calculated, are stored in local storage 104-3 at the video authentication platform 104 in association with the identification of the selected fragments stored at step 202.

Because a hash is generated of only a subset of the total digital video file, that is, the subset being the plurality of fragments identified by the AI agent 104-1, there is a relatively small amount of video data that needs to be hashed, while still achieving good authentication results, since the AI agent 104-1 has specifically identified/selected the plurality of fragments, as explained above.

At step 204, the generated hashes of the selected plurality of fragments are then sent from the local storage 104-3 to a blockchain 103 for secure tamperproof storage (this is also shown in FIG. 3). The blockchain 103 can be a public blockchain, a private blockchain, or a decentralised blockchain, and may involve the use of a smart contract to govern the functions of storing and retrieving data from the blockchain. A plurality of such blockchains could also be used in combination.

This therefore ends the processing that takes place when a new digital video file is first being introduced to the network of FIG. 1.

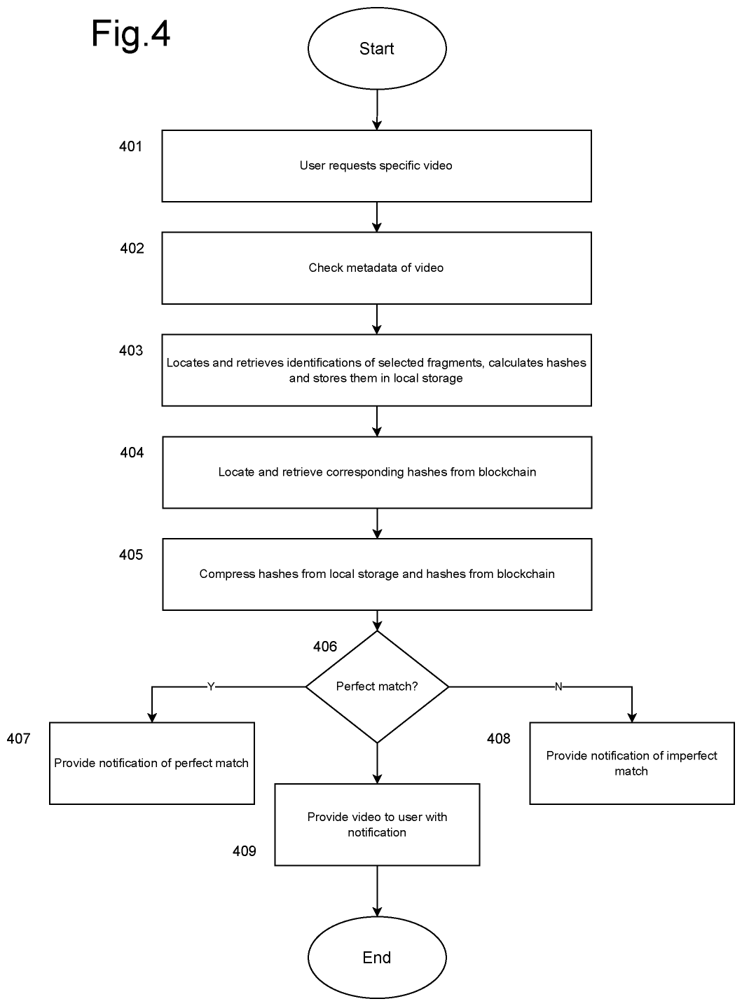

Then, at a later time, when a user of a consumer device 102 (e.g., a smartphone or television) wants to watch a particular video, a series of steps are carried out at the video authentication platform 104 as shown in FIG. 4.

At step 401, the user would make a request for the video to the video serving platform 101 (which could be, for example, You Tube or Netflix). The video serving platform 101 would first send the digital video file of the video, along with any associated metadata, to the video authentication platform 104 where the AI agent 104-1 checks (step 402) the metadata, where it is provided, in the video to recognise the video and to recognise the source that the video has come from (e.g., the identity of the video serving platform or the identity of the originator of the video, such as the BBC, CNN, Sky News etc).

Then, at step 403, the AI agent, or other processing unit within the platform 104 retrieves the identifications of the selected fragments in local storage 104-3 (the fragments that were previously selected by the AI agent 104-1 in step 202) and uses hashing data processing unit 104-2 to calculate the hashes of the selected plurality of fragments of the digital video file that has just been provided by the video serving platform 101, and stores the result in local storage 104-3.

At step 404, the platform 104 then retrieves the corresponding hashes from the blockchain 103 and compares (step 405) the hashes from the local storage with the hashes from the blockchain. Specifically, this comparison is being carried out between: a) the hashes of the selected fragments of the video that was just received by the platform 104 after the consumer device 102 has requested to view the video, and b) the hashes of the selected fragments of the video that was received by the platform 104 when the video was first introduced to the platform by the originator of the video (in accordance with the steps of FIG. 2).

At step 406, if the comparison at step 405 has determined that the hashes at a) and b) match perfectly, then control flows to step 407 where a notification is provided to the consumer device 102 (for example, a green colour could be used) to indicate to the user of the consumer device 102 that the video has been determined to be authentic, by the video authentication platform 104 (that is, there is 99% certainty that the state and content of the video has not changed from the time it was first introduced to the platform 104).

On the other hand, at step 406, if the comparison has determined that the hashes do not match perfectly, then it is likely that the video has been altered as compared to the state of the video when the video was first sent to the video authentication platform 104. It could be, for example, that the identified plurality of fragments is 3 fragments, and the hashes of two of the fragments match, but the hashes of the third fragment does not match. In that case, for example, an amber (orange) colour could be used for providing a notification (step 408) to the consumer device 102, to alert the consumer device that most of the video has not been altered but a portion of the video has been altered.

It could also be, for example, that, where the plurality of fragments is 3 fragments, and the hashes of all three of the fragments do not match between a) and b), then a red coloured warning should be used to warn the user of the consumer device 102 that the video currently being served by the video serving platform 101 is most likely a fake (completely, or almost completely, altered from its original form).

Proceeding from step 407 or 408, whichever the case may be, control then flows to step 409 where the video is then provided to the user of the consumer device 102 together with the coloured notification, according to a preferred embodiment.

As shown in FIG. 3, as a final check, the hash of the sum of the hashes of the selected plurality of fragments can also be generated (see 304) and stored in the blockchain, to help provide further authentication of a video. Such a sum of the hashes would also be generated from a video file just received after a user requests to view the video, and these two sums of hashes can be compared in a similar way to the comparison of the individual hashes as described above. The two comparison results can then be considered together by the platform 104 to make a better determination of video authenticity.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms, etc.) thereto.

What is claimed is:

1. A method of authenticating a digital video file on a video authentication data processing platform, comprising steps of:
(a) receiving a digital video file which is being introduced to the video authentication data processing platform;
(b) processing the received digital video file using an artificial intelligence (AI) agent, which includes an artificial neural network, resulting in identifying a plurality of fragments of the received digital video file which are determined by the AI agent as being authentication candidates which are representative of an entirety of the received digital video file;
(c) generating a hash of each of the plurality of fragments of the received digital video file; and
(d) storing the generated hashes on a blockchain.

2. The method of claim 1 wherein, after the steps a)-d) are performed, when a user sends a user request from a video consumer device, to view the digital video file, the further steps are carried out:
(e) the digital video file is again received by the video authentication data processing platform in response to the user request,
(f) a hash is again generated of each of the plurality of fragments of the digital video file received at step (e); and
(g) the hashes stored on the blockchain at step (d) are compared to the hashes generated at step (f); and
(h) if the comparison result at step (g) indicate a match, then a notification is provided to the video consumer device to notify the user that the digital video file has been authenticated.

3. The method of claim 1, wherein at step (b), the plurality of fragments are vertical frames of the digital video file.

4. The method of claim 1, wherein at step (b), the plurality of fragments are horizontal fragments of the digital video file.

5. The method of claim 1, wherein at step (a), metadata associated with the digital video file is also received and used by the AI agent at step (b) to identify the plurality of fragments.

6. The method of claim 5 wherein the metadata includes any one of a name of the digital video file, a data when the digital video file was created, a data format of the digital video file, or a compression type of the digital video file.

7. The method of claim 1 wherein a hash is also generated of a sum of the hashes generated at step (c), and the hash of the sum of the hashes is also stored on the blockchain at step (d).

8. The method of claim 1 wherein at step (b) the AI agent identifies the plurality of fragments by recognising specific characteristics of the digital video file.

9. The method of claim 8 wherein the specific characteristics of the digital video file include a specific colour appearing in a specific portion of the digital video file.

10. The method of claim 8 wherein the specific characteristics of the digital video file include an identification of a particular person whose face appears in the digital video file, by using a facial recognition algorithm.

11. The method of claim 2, wherein, at step (h), if the comparison result at step (g) indicates that the hashes do not match, then a notification is provided to the video consumer device to notify the user that the digital video file has not been authenticated.

12. The method of claim 2 further comprising the step (i) of providing the digital video file to the video consumer device.

13. A system for authenticating a digital video file on a video authentication data processing platform, the system comprising:
a processor; and
a memory storing instructions that, when executed on the processor, cause the system to perform the steps of:
(a) receiving a digital video file which is being introduced to the video authentication data processing platform;
(b) processing the received digital video file using an artificial intelligence (AI) agent, which includes an artificial neural network, resulting in identifying a plurality of fragments of the received digital video file which are determined by the AI agent as being authentication candidates which are representative of an entirety of the received digital video file;
(c) generating a hash of each of the plurality of fragments of the received digital video file; and
(d) storing the generated hashes on a blockchain.

14. A non-transitory computer-readable device having instructions stored thereon that, when executed by at least one computing device, cause the at least one computing device to perform operations comprising:
(a) receiving a digital video file which is being introduced to the video authentication data processing platform;
(b) processing the received digital video file using an artificial intelligence (AI) agent, which includes an artificial neural network, resulting in identifying a plurality of fragments of the received digital video file which are determined by the AI agent as being authentication candidates which are representative of an entirety of the received digital video file;
(c) generating a hash of each of the plurality of fragments of the received digital video file; and
(d) storing the generated hashes on a blockchain.
